(19) United States
(12) Patent Application Publication
(10) Pub. No.: US 2016/0236033 A1
(43) Pub. Date: Aug. 18, 2016

(54) SYSTEM AND METHOD FOR RECORDING EXERCISE DATA AUTOMATICALLY

(71) Applicant: ZAN QUAN TECHNOLOGY CO., LTD, Taipei City (TW)

(72) Inventors: Kai-Li WANG, Taipei City (TW); Hsia-Hung OU, Taipei City (TW)

(73) Assignee: ZAN QUAN TECHNOLOGY CO., LTD, Taipei City (TW)

(21) Appl. No.: 15/041,480

(22) Filed: Feb. 11, 2016

(30) Foreign Application Priority Data
Feb. 17, 2015 (TW) 104105545

(51) Int. Cl. A63B 24/00; H04N 5/765; G06K 9/32; G06F 3/16; G06K 9/00; G06K 9/20

(52) U.S. Cl. CPC A63B 24/00; G06K 9/00724; G06K 9/209; G06K 9/32; G06F 3/16; H04N 5/765

(57) ABSTRACT

A system and a method to record exercise data automatically are provided. The system includes an identification device, an image capturing module, a database, and a management module electrically connected to the database. In operation, the image capturing module captures a signal source of the identification device, and tracks an object equipped with the identification device correspondingly so as to achieve an effect of recording automatically. Therefore, the interest, interaction and broadcasting effects of static or dynamic images of sport activities such as a sport game are improved.

### CROSS REFERENCE TO PRIOR APPLICATION

This application claims priority to and the benefit thereof from Taiwan patent application No. 104105545, filed on Feb. 17, 2015, the entire disclosure of which is hereby incorporated by reference herein.

### TECHNICAL FIELD

This disclosure relates to techniques for recording exercise data, and, more particularly, to a system and a method that record exercise data automatically.

### BACKGROUND

In recent years, people have been aware of the importance of exercise. With the rapid development of technology, a variety of exercise events are broadcast globally. The booming of the network facilitates the sharing of exercise data relating to games and performances (e.g., the exercise data or images of an athlete). As such, other athletes can be encouraged by the shared exercise data.

However, the history data of an athlete (e.g., the name of the athlete, scoring events, or the role of a player playing in a game) has been recorded manually. It also takes labors to capture (i.e., record) an image of an athlete and generate images of the athlete, and play music corresponding to the game atmosphere. In other words, the recording of the history data of the athlete, the capturing of the image, and the playing of the music are performed individually, which increases the labor costs and expenditures for holding a contest or exercise.

Moreover, the exercise data generated by assembling the performance data and captured images of the athlete cannot be obtained until the game is over, which adversely affects the real time provision of the exercise data. People cannot view the replayed images by themselves.

An automatic capturing apparatus has come to the market. The automatic capturing apparatus can capture the images of the athlete in accordance with the movement of the athlete. However, the automatic capturing apparatus can only follow the athlete and captures the images of the athlete himself/herself, and still cannot solve the problem of the prior art that the recording of the history data of the athlete, the capturing of the image, and the playing of the music are performed individually.

Therefore, how to solve the problems of the prior art is becoming an urgent issue in the art.

### SUMMARY

In view of the problems of the prior art, the present disclosure provides a system to record exercise data automatically, comprising: an identification device having a signal source; an image capturing module configured to capture the signal source and capture a moveable object to generate a static or dynamic recorded image; a database configured to store the recorded image transmitted by the image capturing module; and a management module electrically connected to the database and configured to receive the recorded image and generate at least one specific image.

Also, the present disclosure provides a method of recording exercise data automatically, comprising: enabling an identification device to generate a signal source according to a sensing device equipped to a moveable object; capturing the signal source to capture the movable object equipped with the identification device to generate a recorded image; processing the signal source to determine a dynamic state of the movable object; generating a display instruction according to the dynamic state of the movable object; providing location data of a signal transceiver of the identification device equipped to the movable object; and assembling the location data, the recorded image and the display instruction to generate the exercise data of the movable object.

In a system and a method that record exercise data automatically according to the present disclosure, through a transmission transceiving principle of a signal source of an identification device, an image capturing module can track the identification device correspondingly, so as to achieve the effect of shooting automatically. Therefore, the interest, interaction and broadcasting effects of static or dynamic images of sport activities such as a sport game are improved.

### BRIEF DESCRIPTION OF DRAWINGS

The disclosure can be more fully understood by reading the following detailed description of the preferred embodiments, with reference made to the accompanying drawings, wherein:

FIG. 1 is a functional block diagram of a system to record exercise data automatically according to the present disclosure; and

FIGS. 2A-2D are flow charts illustrating a method of recording exercise data automatically according to the present disclosure.

### DETAILED DESCRIPTION

The following illustrative embodiments are provided to illustrate the disclosure of the present disclosure, these and other advantages and effects can be apparently understood by those in the art after reading the disclosure of this specification. The present disclosure can also be performed or applied by other different embodiments. The details of the specification may be on the basis of different points and applications, and numerous modifications and variations can be devised without departing from the spirit of the present disclosure.

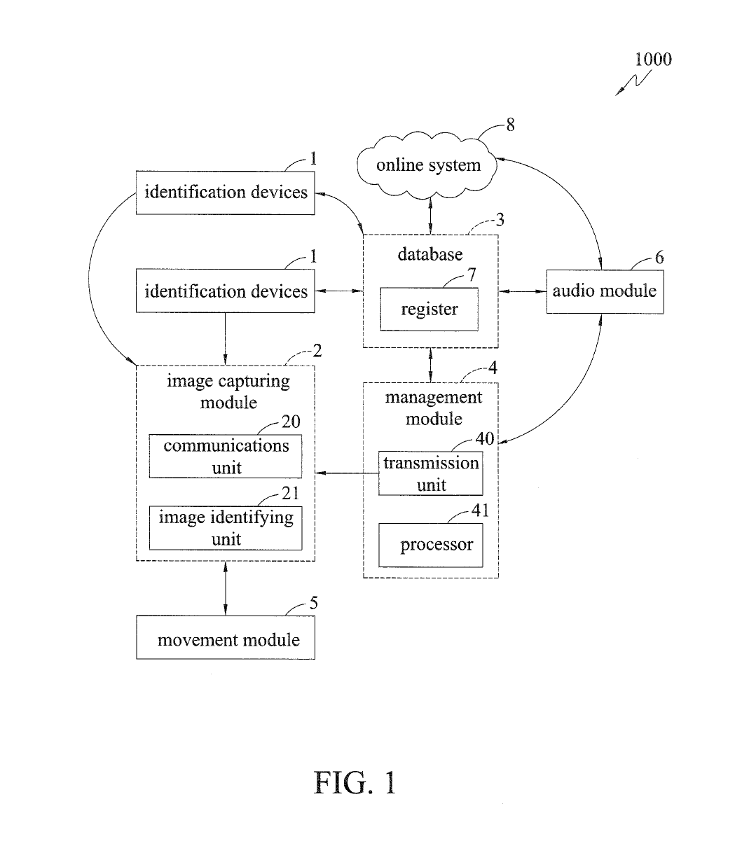

Refer to FIG. 1, which is a functional block diagram of a system 1000 to record exercise data automatically. The system 1000 comprises a plurality of identification devices (e.g., RFID devices) 1, an image capturing module 2, a database 3, a management module 4, a movement module 5, an audio module 6, a register 7 and an online system 8.

The identification device 1 is used for the image capturing module 2 to identify an object to be shot. The identification device 1 comprises a sensing device (not shown) equipped to a moveable object (e.g., human, ball or vehicle), allowing the identification device 1 to generate a signal source according to the sensing device. The identification device 1 outputs the signal source, and the image capturing module 2 captures the signal source. The identification device 1 can also transmit the signal source to the database 3 or the register 7 for storage.

The signal source has auxiliary data of the object, including, but not limited to sensing data, movement data and location data. The signal source may have other auxiliary data, or have only some of the sensing data, the movement data and the location data. The sensing data are used to be captured by the image capturing module 2 to identify the object to be shot. The movement data are speed, velocity or acceleration of the object that is sensed. The location data are the location data where the object stays that are generated by a global positioning system (GPS) or a combination of a plurality of longitude and latitude values. The location data can be integrated to obtain history movement location data of the object.

The management module 4 comprises a transmission unit 40 and a processor 41. The management module 4 transmits through the transmission unit 40 the signal source stored in the database 3 or the register 7 to the processor 41, allowing the processor 41 to use an algorithm process to process the signal source and generate control instructions. The transmission unit 40 outputs the control instructions directly to the image capturing module 2 or to the database 3 for storage, for the image capturing module 2 to capture the control instructions. The control instructions can be output to the image capturing module 2 and the database 3 at the same time. The control instructions comprise moving history data. The processor 41 gets to know the history moving velocity of the object according to the movement data of the signal source, calculates and predicts the current moving velocity of the object, and generates the moving history data. Therefore, the image capturing module 2, when losing signal connection, can still keep shooting the object according to the moving history data. The control instructions may further comprise other digital information relating to the controlling of the image capturing module 2.

Therefore, the image capturing module 2 can capture the signal source output by the identification device 1, the control instructions stored in the database 3, or the control instructions output by the transmission unit 40, and identify the object equipped with the sensing device of the identification device 1 that is to be captured, to generate a static or dynamic recorded image and output the recorded image to the database 3 or the register 7 for storage.

The management module 4 receives through the transmission unit 40 the static or dynamic recorded image stored in the database 3 or the register 7, and the processor 41 gives a code with information (e.g., the name or location of the object) to the recorded image to generate a coded image. The processor 41 processes the coded image with a predefined value (e.g., the relative position of signal sources within a specific region, a specific region, or specific time), to capture a portion of the coded image that matches the predefined value, and generate at least one specific image or a combination of different specific images. The transmission unit 40 outputs the recorded image, the coded image, specific image or the combination of the different specific images to the database 3 for storage.

The management module 4 and the database 3 can be separated from each other, or integrated into an independent system. The register 7, the management module 4 and the database 3 can be separated from one another, or at least two of them can be integrated into an independent system. The above arrangements can be changed on system design demands. The register 7 stores the data transmitted by the identification device 1, the image capturing module 2 or the management module 4, to improve the efficiency of processing data.

The image capturing module 2 is electrically connected to the movement module 5. The movement module 5 drives the image capturing module 2 to move with the displacement of the object equipped with the identification device 1 according to the signal source or the control instructions captured by the image capturing module 2, allowing the image capturing module 2 to shoot the object within a specific region. A route map can be given to the image capturing module 2, and the image capturing module 2 captures the static or dynamic recorded image generated by the object equipped with the identification device 1 on the route map according to the route map. When the signal source or the control instructions captured by the image capturing module 2 loses connection, the image capturing module 2, based on the moving history data in the captured control instructions, enables the movement module 5 to calculate the moving history data of the current moving velocity of the object, and gets to know the route map of a direction in which the object is going to move. These two data can be combined, and drive the image capturing module 2, when the image capturing module 2 loses the signal connection, to keep moving in the original direction and shooting the object.

The image capturing module 2 comprises a communications unit 20 and an image identifying unit 21. The communications unit 20 receives the signal source of the identification device 1. The image identifying unit 21 assists in identifying the object, to improve the accuracy of the static or dynamic recorded image generated by the image capturing module 2 when capturing the object.

The history data of the object are stored in the database 3, or the database 3 is electrically connected to the online system 8, allowing the database 3 to store the history data of the object output by the online system 8.

The processor 41 of the management module 4 may assemble the signal source, the control instructions, the history data and the recorded image, the coded image, the specific image or at least one of the different specific images, to generate exercise data of the object. The transmission unit 40 outputs the exercise data to the database 3 to update the history data of the object.

The specific image or the combination thereof of the object, the recorded image, and the coded image can be known through the history data. Since the database 3 is electrically connected to the online system 8, the database 3 and the online system 8 can exchange their exercise data, and the exercise data can be shared online.

The processor 41 of the management module 4 uses an algorithm process to process the signal source equipped with the identification device 1, and gets to know the dynamic state (e.g., the relative position of signal sources within a specific region, a specific region, or specific time) of the object equipped with the identification device 1. The processor 41 further uses a predefined suitable value to perform an analysis and comparison process according to the dynamic state, and generates a display instruction. The display instruction can also be generated by identifying the identity of the object through the signal source. The transmission unit 40 outputs the display instruction to the database 3, the audio module 6 or both, and the audio module 6 receives the display instruction and captures music data from the database 3 or the online system 8, to generate music of the object in a dynamic state equipped with the identification device 1, to excite the atmosphere on the spot.

The embodiments, which are described for illustration only, of a system 1000 for recording exercise data automatically according to the present disclosure are described as follows.

In a first embodiment of ball games (e.g., basketball or succor), the sensing device of the identification device 1 can be installed on a rim basket, a ball, a plurality of players, or any object relating to the court. The identification device 1 generates the signal source according to the sensing device. The image capturing module 2 (e.g., a camera) captures the corresponding player according to the signal source of the identification device 1, or the identification device 1 transmits the signal source to the database 3 or the register 7 for storage, allowing the management module 4 to output the signal source stored in the database 3 or the register 7 through the transmission unit 40 to the processor 41, and allowing the processor 41 to use an algorithm process to process the signal source and generate control instructions. The transmission unit 40 outputs the control instructions directly to the image capturing module 2 or to the database 3 for storage, allowing the image capturing module 2 to capture the control instructions.

The image capturing module 2 captures the signal source output by the identification device 1, the control instructions stored in the database 3, or the control instructions output by the transmission unit 40, and identifies the object equipped with the identification device 1 that is to be shot. For example, the image capturing module 2, when identifying a player to be shot, shoots the player and generates a static or dynamic recorded image of the player, and outputs the recorded image to the database 3 or the register 7 for storage.

Through the control instructions generated by the processor 41 after performing the algorithm process, when the court has the ball, the players and a plurality of image capturing module 2, the image capturing modules 2 can readily determine the players that need to be recorded, and control or change the player to be recorded, to achieve the effect of recording in coordination with the image capturing modules 2.

The image capturing module 2 captures through the image identifying unit 21 predefined captured image values of the player, such as the cloth and face, to improve the accuracy of the image capturing module 2 when recording the player.

The image capturing module 2 drives the movement module 5 (e.g., a light helicopter or a moveable mechanism) according to the signal source of the identification device 1 or the control instructions, and moves through the movement module 5 according to the displacement of the moveable object (e.g., the player) equipped with the identification device 1. As such, the image capturing module 2 may capture the image of the player in the court.

The management module 4 receives through the transmission unit 41 the static or dynamic recorded image stored in the database 3 or the register 7. The processor 41 generates through the information a code for the recorded image to generate the coded image, and processes the coded image with a predefined value, to capture a portion of the static or dynamic coded image that matches with the predefined value, and generate at least one specific image or a combination thereof, such as, but not limited to a specific image of a player who scores in a specific time zone, or a combination of different specific images of the player who scores every time.

In a first embodiment, the relative position of the players can be known through the location data of the signal sources within predefined regions of the court. The coded image is processed according to the relative position or the specific time zone and specific time point before scoring, and a predefined value is generated. For example, the timing of scoring in the basketball game can be determined when the ball passes through the rim basket and the sensing device equipped to the rim basket generates a signal.

The database 3 stores the history data of the player (e.g., name, height, age, scoring history, the role the player plays, or the scoring rate). The database 3 can also be electrically connected to the online system 8, and stores the history data of the object output by the online system 8.

The identification device 1 records through the sensing device the location data of the player during his exercise process, and outputs the location data to the database 3 or the register 7 for storage. For a single player or a plurality of players, the management module 4 may assemble through the processor 41 at least two of the location data, the history data and the recorded image, the coded image, the specific image or a combination of different specific images, and output through the transmission unit 40 the exercise data to the database 3 for storage and update the history data of the player. It is thus known from the updated history data that the specific images of scoring and role of the player or a combination thereof, the coded image and the recoded image of the player while playing in the ball game, or the combined exercise value of the player.

The database 3 is electrically connected to the online system 8, and can exchange data with the online system 8, and the exercise data can be shared with others online. Since the identification device 1 is equipped to the ball, the interest, interaction and broadcasting effect of static or dynamic images of sport activities such as sport game are improved.

The processor 4 uses an algorithm process to perform an analysis and comparison process on the signal source of the identification device 1 equipped to the player, and gets to know the dynamic state of a plurality of players in a ball game. The determination of the dynamic state is the same as the determination of the predefined value of the specific image, further description hereby omitted. The processor 41 performs an analysis process with a predefined suitable value according to the dynamic state to generate a display instruction. The display instruction can also be generated by identifying the identification of the exercise through the signal source. The transmission unit 40 outputs the display instruction to the database 3, the audio module 6, or both. The audio module 6 receives the display instruction and captures from the database 3 and the online system 8 music data, to generate music data of the dynamic state of the players or music data dedicated to the specific player during the ball game, so as to excite the atmosphere on the spot, and enable the image capturing module 2 to capture dynamic images that are more amusing and interesting.

The processor 41 of the management module 4 further takes the display instruction and the music data as the factor for assembly, and further generates the exercise data having the display instruction and the music data, such that the exercise data have improved popularity, amusement and broadcasting effect.

It is known from the above that the present disclosure records exercise data automatically, uses an image capturing module to capture static or dynamic recorded images of a player in the court automatically, assembles the captured specific images and the location data and history data of the player, and uses the audio module to generate suitable music data when the player is exercising and generates real time or non-real time exercise data of the player. Therefore, the history data of the player is recorded, the shooting of the images and the playing of the music can be performed simultaneously to record the exercise data, and the real time or non-real time scoring images, scoring location data and combined values of the player can be integrated, such that the real time sharing effect of the exercise data of the ball game can be improved, and the human labors and cost needed to hold a contest or exercise are reduced.

In a second embodiment of a racing exercise (e.g., swimming, running or bike-racing), for an athlete or a plurality of athletes an additional route map is given to the image capturing module 2, allowing the image capturing module 2 to capture on the route map the signal source of the athlete equipped with the sensing device of the identification device 1 or the control instructions obtained after the management module 4 performs the algorithm process, to drive the movement module 5 electrically connected to the image capturing module 2 and drive the image capturing module 2 to track and capture the athlete equipped with the identification device 1 on the route map, so as to capture the static or dynamic recorded images of the athlete.

In the second embodiment, when the signal source captured by the image capturing module 2 or the control instructions lose connection when the athlete dives into water and rides his bike into a cave such that the signal source cannot be transmitted or the control instructions cannot be generated, the movement module 5 may calculate, through the moving history data in the control instructions captured by the image capturing module 2 and the route map, the moving history data of the current moving velocity of the object, and get to know the route map of a direction in which the object is ready to move. These two data can be combined, such that the image capturing module 2, when losing the signal connection, can still move along the original direction and keep shooting the object.

The application of the system 1000 for recording exercise data automatically to the second embodiment is the same as that of the system 1000 to the first embodiment, further description hereby omitted.

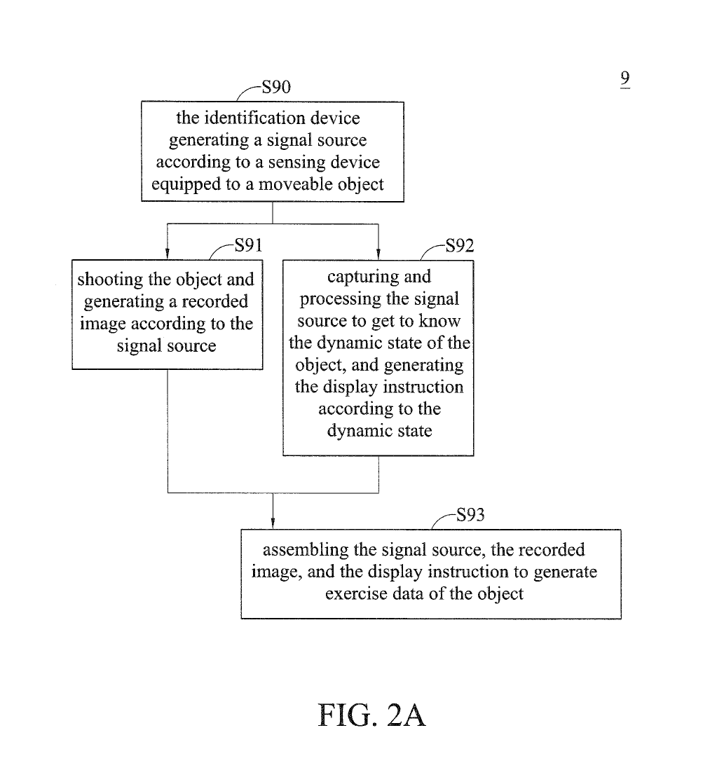

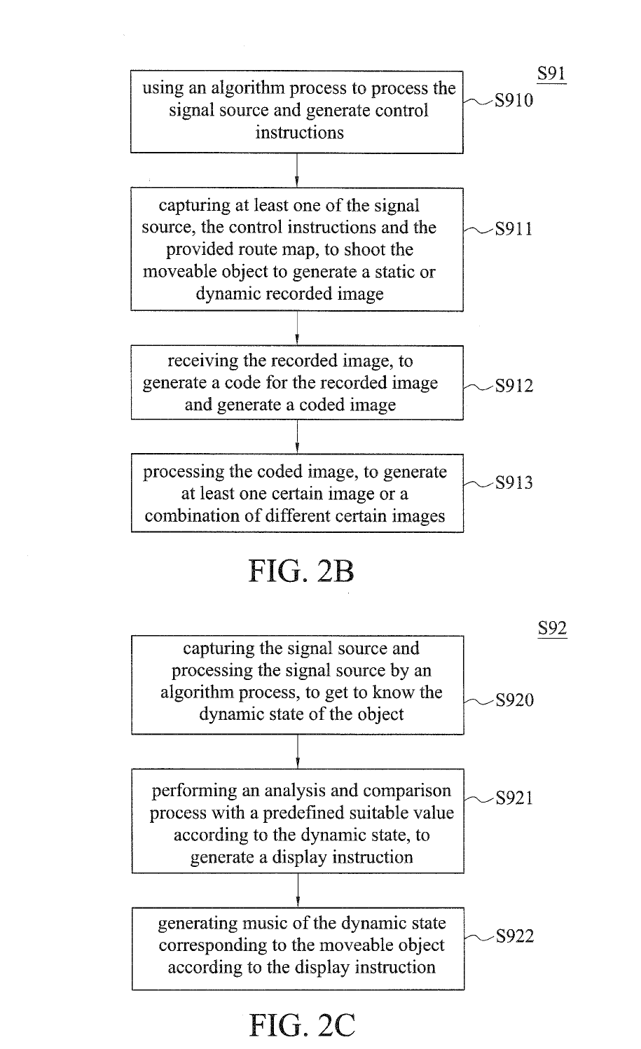

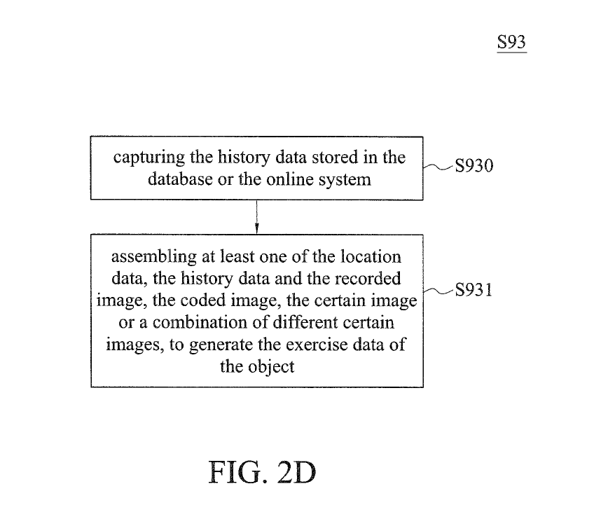

Referring to FIG. 2A, which is a flow chart of a method 9 for recording exercise data automatically according to the present disclosure. The method 9 comprises steps S90-S93.

In step S90, the identification device generates at least one signal source according to a sensing device equipped to at least one moveable object, and the signal source is transmitted to at least one of the database and the register for storage. The signal source comprises auxiliary data of the object, such as sensing data, movement data and location data. The method 9 proceeds to step S91 or step S92. In step S91, the image capturing module captures the object and generates a recorded image and a specific image according to the signal source. In step S92, the signal source is captured and processed to get to know the dynamic state of the object, and the display instruction is generated according to the dynamic state. In step S93, the signal source, the recorded image, the specific image and the display instruction are assembled to generate exercise data of the object.

The details of steps S91, S92 and S93 are described in the following paragraphs.

The sensing data are used as data for identifying the object to be captured. The movement data are the data of the object after sensed, such as speed, velocity or acceleration of the object. The location data is the location data where the object stays that are generated by a GPS or a combination of a plurality of longitude and latitude values.

Please refer to FIG. 2B at the same time. Step S91 includes steps S910, S911, S912 and S913. In step S910, an algorithm process is used to process the signal source and generate control instructions. The method 9 then proceeds to step S911. In step S911, at least one of the signal source, the control instructions and the provided route map is captured, to capture the moveable object to generate a static or dynamic recorded image. The method 9 proceeds to step S912. In step S912, the recorded image is received, to generate a code for the recorded image and generate a coded image. The method 9 then proceeds to step S913. In step S913, the coded image is processed with a predefined value (e.g., the relative position of signal sources within a specific region, a specific region, or specific time), to generate at least one specific image or a combination of different specific images.

The control instructions include moving history data. The moving history data get to know the history moving velocity of the object according to the movement data of the signal source, and calculate and predict the current moving velocity of the object. Therefore, the image capturing module, when losing connection, can calculate the current moving velocity of the object according to the moving history data, and get to know the direction in which the object is ready to move according to the route map. These two data can be combined, and the image capturing module can keep moving in the original direction and shooting the object.

Please refer to FIG. 2C at the same time. Step S92 includes steps S920, S921 and S922. In step S920, the signal source is captured and processed by an algorithm process, to get to know the dynamic state (e.g., the relative position of signal sources within a specific region, a specific region, or specific time) of the object. The method 9 proceeds to step S921. In step S921, an analysis and comparison process in performed with a predefined suitable value according to the dynamic state, to generate a display instruction, or the identification of the object is identified according to the sensing data of the signal source to generate the display instruction. The method proceeds to step S922. In step S922, music of the dynamic state corresponding to the moveable object is generated according to the display instruction.

Please refer to FIG. 2D at the same time. Step S93 includes steps S930 and S931. In step S930, the history data stored in the database or the online system are captured. The method 9 then proceeds to step S931. In step S931, at least one of the location data, the history data and the recorded image, the coded image, the specific image or a combination of different specific images are assembled, to generate the exercise data of the object.

The present disclosure provides a system and a method for recording exercise data automatically. Through a transmission transceiving principle of a signal source of an identification device, an image capturing module can track the identification device correspondingly, so as to achieve the effect of shooting automatically. Therefore, the interest, interaction and broadcasting effect of static or dynamic images of sport activities such as sport game are improved.

The audio module captures the display instructions generated by the processor after analyzing the current dynamical state, and suitable audio data can be selected from the database or the online system, to assist the effect of bring the atmosphere alive.

The database stores the history data of the athlete and the location data of the exercise process stored in the database and transmitted by the identification device. The processor integrates the static or dynamic images, history data, audio data and location data, to obtain the location of a special event (e.g., a scoring event) of the athlete and an exciting image of the location. The history data (e.g., the scoring rate, moving position or playing time of the athlete) of the athlete are assembled, and the current exercise data of the player can be calculated. Through the combination of the present disclosure with the network online system, the exercise data can be shared with other people globally, and the views can replay exciting play by himself.

The shooting and recording processes are performed by an electronically operating process, and the cost of holding a contest is reduced effectively.

The foregoing descriptions of the detailed embodiments are only illustrated to disclose the features and functions of the present disclosure and not restrictive of the scope of the present disclosure. It should be understood to those in the art that all modifications and variations according to the spirit and principle in the disclosure of the present disclosure should fall within the scope of the appended claims.

What is claimed is:

1. A system to record exercise data automatically, comprising:
an identification device having a signal source;
an image capturing module configured to capture the signal source and capture a moveable object to generate a static or dynamic recorded image;
a database configured to store the static or dynamic recorded image transmitted by the image capturing module; and
a management module electrically connected to the database, and configured to receive the static or dynamic recorded image and generate at least one specific image.

2. The system of claim 1, wherein the identification device further comprises:
a sensing device equipped to the movable object, and is configured to generate the signal source according to the sensing device.

3. The system of claim 1, wherein the image capturing module comprises an image identifying unit configured to assist in identifying the captured moveable object.

4. The system of claim 1, further comprising:
a movement module electrically connected to the image capturing module and configured to drive the image capturing module to move in accordance with a displacement of the movable object equipped with the identification device.

5. The system of claim 1, wherein the image capturing module is further configured to receive a route map and capture the static or dynamic recorded image generated from the movable object equipped with the identification device according to the route map.

6. The system of claim 1, further comprising:
an audio module configured to generate music data corresponding to the identification device.

7. The system of claim 6, wherein the identification device comprises a signal transceiver configured to generate location data and output the location data to the database for storage.

8. The system of claim 7, wherein the database is further configured to store history data of the movable object.

9. The system of claim 8, further comprising:
a processor configured to assemble the location data, the music data, the history data and the at least one specific image, or a combination of the at least one specific image to generate the exercise data of the movable object.

10. The system of claim 1, further comprising:
an online sub-system electrically connected to the database and configured to share the exercise data online.

11. The system of claim 1, wherein the management module further comprises:
a processor configured to:
use an algorithm process to process the signal source and generate control instructions,
generate a code for the static or dynamic recorded image to generate a coded image, and
process the coded image to generate the at least one specific image; and
a transmission unit configured to transmit the coded image or the specific image to the database, or transmit the control instructions to the image capturing module.

12. The system of claim 11, further comprising:
a register configured to store the signal source, the dynamic recorded image or the control instructions accessible by the management module.

13. A method of recording exercise data automatically, the method comprising:
enabling an identification device to generate a signal source according to a sensing device equipped to a moveable object;
capturing the signal source to capture the movable object equipped with the identification device to generate a recorded image;
processing the signal source to determine a dynamic state of the movable object;
generating a display instruction according to the dynamic state of the movable object;
providing location data of a signal transceiver of the identification device equipped to the movable object; and
assembling the location data, the recorded image and the display instruction to generate the exercise data of the movable object.

14. The method of claim 13, further comprising:
using an algorithm process to process the signal source and generate control instructions.

15. The method of claim 14, further comprising:
capturing at least one of the signal source, the control instructions and a route map to capture the moveable object and generate a static or dynamic recorded image.

16. The method of claim 13, further comprising:
receiving the recorded image to generate a code for the recorded image and generate a coded image.

17. The method of claim 16, further comprising:
processing the coded image to generate at least one specific image.

18. The method of claim 17, further comprising:
assembling the coded image and the at least one specific image to generate the exercise data of the movable object.

19. The method of claim 13, further comprising:
processing the signal source with an algorithm process to determine a dynamic state of the moveable object;
performing an analysis and comparison process with a predefined value according to the dynamic state to generate a display instruction; and
assembling the display instruction to generate the exercise data of the movable object.

20. The method of claim 13, further comprising:
capturing history data stored in a database or an online system to assemble the history data and generate the exercise data of the movable object.
